(19) United States
(12) Patent Application Publication
(10) Pub. No.: US 2023/0204363 A1
(43) Pub. Date: Jun. 29, 2023

(54) METHOD FOR IMPROVING LOCALIZATION ACCURACY OF A SELF-DRIVING VEHICLE

(71) Applicant: SENSIBLE 4 OY, Espoo (FI)

(72) Inventor: Tuomas TIIRA, Espoo (FI)

(73) Assignee: SENSIBLE 4 OY, Espoo (FI)

(21) Appl. No.: 17/927,570

(22) PCT Filed: May 26, 2020
(86) PCT No.: PCT/FI2020/050353

§ 371 Date: Nov. 23, 2022

(51) Int. Cl. G01C 21/30; B60W 60/00; B60W 50/06; G06T 7/60; G06T 7/70; G06T 7/50

(52) U.S. Cl. CPC G01C 21/30; B60W 60/001; B60W 50/06; G06T 7/60; G06T 7/70; G06T 7/50; B60W 2050/0057

(57) ABSTRACT

The invention relates to a method for improving localization accuracy of a self-driving vehicle (100). The method comprises steps of receiving from one or more range sensing devices (110) point cloud data related to surface (130) characteristics of an environment of a self-driving vehicle (100), and based on receiving, constructing a modified normal distributions transform (NDT) histogram having a set of Gaussian distributions in a plurality of histogram bins, each of the plurality of histogram bins providing different constraining features, performing subsampling for each histogram bins in the constructed NDT histogram, in which subsampling a number of Gaussian distributions from each histogram bin is removed to construct a vector h^{S} representing the target height of each histogram bin, and after subsampling, selecting hᵢ^{S} Gaussian distributions from the corresponding histogram bins of vector h^{S} based on the constraining features given by the Gaussian distributions and adding them to the subsample set S in order to localize the self-driving vehicle (100)) with respect to the point cloud data received.

### TECHNICAL FIELD

The invention relates to a method for improving localization accuracy of a self-driving vehicle.

### BACKGROUND

For self-driving vehicles using range sensing devices, such as 3D LiDAR, sparse environments, such as empty parking lots and open fields, can be problematic for map-based localization if amount of constraining features for the LiDAR point cloud matching process is low. For example, if the LiDAR scan mostly consists of measurements from a flat ground, the estimated transformation between the LiDAR scan and the LiDAR map can be inaccurate along the ground plane. Inaccuracy can lead to dangerous situations in the traffic if the estimated pose of a vehicle is incorrect.

Additionally, the computational load of this kind of localization methods can be very high due to the high amount of data points needed to be processed to match the LiDAR points to a LiDAR map. Even though using a known 3D normal distributions transform (3D-NDT) (in M. Magnusson, A. Lilienthal, and T. Duckett, “Scan registration for autonomous mining vehicles using 3D-NDT,” Journal of Field Robotics, vol. 24, no. 10, pp. 803-827, 2007) and L₂ distance based matching (in T. Stoyanov, M. Magnusson, H. Andreasson, and A. J. Lilienthal, “Fast and accurate scan registration through minimization of the distance between compact 3D NDT representations,” The International Journal of Robotics Research, vol. 31, no. 12, pp. 1377-1393, 2012) can be very efficient, the localization methods can still struggle to operate in real-time when using a moderate CPU and a 3D LiDAR with high amount of channels. To reduce the computational load, down sampling, i.e. subsampling can be performed to the multivariate Gaussian distributions obtained from 3D-NDT representation of the LiDAR scan.

A problem in known subsampling methods is that some of the Gaussian distributions are simply ignored and therefore there is a risk of removing important features from the scan which provide constraints to the scan alignment process. This can lead into situations where the map-based localization eventually drifts in the direction where there is low amount of constraints. For example, typical situation for self-driving cars in sparse environments is that the result of randomly selected subsample mostly consists of ground hits. The weight of the few constraining features left in the subsample is the same as for the ground hits. Therefore, when performing NDT and L₂ distance based LiDAR scan matching, the alignment is mostly based on how well the distributions from the ground hits match each other. This can lead into inaccurate matching in the directions parallel to the ground plane.

Several approaches to improve localization accuracy in sparse environment are previously known. For example, one known approach is based on normal distribution transform (NDT) in which the NDT histogram was introduced (in M. Magnusson, H. Andreasson, A. Nuchter, and A. J. Lilienthal, “Appearance-based loop detection from 3D laser data using the normal distributions transform,” in IEEE International Conference on Robotics and Automation, pp. 23-28, 2009). In another known approach by Zaganidis et al. (in A. Zaganidis, M. Magnusson, T. Duckett, and G. Cielniak, “Semantic-assisted 3D normal distributions transform for scan registration in environments with limited structure,” in IEEE/RSJ International Conference on Intelligent Robots and Systems, pp. 4064-4069, 2017) a semantic-assisted NDT (SE-NDT) registration method to increase accuracy, robustness and speed of NDT registration especially in environments with limited structure was proposed. The method includes semantic information of the points to the NDT matching procedure to overcome the problem of the smoothness of the Gaussians caused by the NDT in environments with limited structure. In SE-NDT, the Gaussians are constructed from points that are first partitioned based on the per point semantic values. The Gaussians are then matched such that only the distributions created from same partitions of points are compared to each other.

Chen et al. (in J. H. Chen and K. Y. Lum, “Simultaneous localization and mapping based on particle filter for sparse environment,” in IEEE International Conference on Mechatronics and Control, pp. 1869-1873, 2014) have also studied localization accuracy and proposed a FastSLAM based approach using a particle filter (PF) is utilized, where each particle includes an extended Kalman filter (EKF) that estimates one environmental feature in addition to the vehicle's pose. The estimation of the landmarks in the EKF enable more reliable dead reckoning in situations where the landmarks are momentarily not visible.

A study by Wang et al. (in R. Wang, M. Veloso, and S. Seshan, “Multi-robot information sharing for complementing limited perception: A case study of moving ball interception,” in IEEE International Conference on Robotics and Automation, pp. 1884-1889, 2013) proposes to use multiple robots to complement each other's perception by cumulating sensor data acquired by the different robots in sparse environments. The expectation is that the transformation between the robots remain constant and such the transformations are known. Therefore, one robot can utilize the objects detected by other robots to perform more accurate localization in the absence of objects near the robot.

### BRIEF DESCRIPTION OF THE INVENTION

An object of the invention is to alleviate the above-mentioned problems and provide a method for improving the accuracy of map-based localization of a self-driving vehicle in sparse environments.

The object of the invention is achieved by a method which is characterized by what is stated in the independent claims. The preferred embodiments of the disclosure are presented in the dependent claims.

In one embodiment of the present invention, there is provided a method which comprises steps of:
receiving from one or more range sensing devices point cloud data related to surface characteristics of an environment, in which said self-driving vehicle is moving,
based on receiving, constructing a modified normal distributions transform (NDT) histogram having a set of Gaussian distributions in a plurality of histogram bins, each of the plurality of histogram bins providing different constraining features,
constructing a vector h=[h₁, h₂, . . . , h_{N}], where hᵢ is the height of each of the plurality of histogram bin, i∈[1,N] is the index of the histogram bin, wherein the height means the number of Gaussian distributions in a histogram bin, and N is the total amount of the plurality of histogram bins in the NDT histogram,
performing subsampling for each histogram bins in the constructed NDT histogram, in which subsampling a number of Gaussian distributions from each histogram bin is removed to construct a vector h^{s} representing the target height of each histogram bin,
after subsampling, selecting hᵢ^{s} Gaussian distributions from the corresponding histogram bins of vector h^{s} based on the constraining features given by the Gaussian distributions and adding them to the subsample set S in order to localize the self-driving vehicle with respect to the point cloud data received.

In one embodiment the above-mentioned step of constructing a modified NDT histogram further comprises:
providing distance measure data around said one or more range sensing devices, and based on providing, resulting point cloud data to form a set of Gaussian distributions,
clustering said Gaussian distributions based on the constraining features provided by said distributions, in which the clustering is executed by modifying said distributions such that the distributions acquired from the ground, that is from the ground hits of the distance measure data, are separated in an additional histogram bin.

In one embodiment the method further comprises:
dividing said distance measure data in multiple layers based on the heights of said distributions, where the height is the distance in the direction perpendicular to the ground, along which said self-driving vehicle is moving, and grouping said distance measure data in subsets Gᵢ∈G, where i is the index of a layer, and then
selecting the subset Gᵢ with the largest amount of distributions as the ground and the remaining non-ground distributions are clustered in different histogram bins.

In one embodiment the method further comprises:
constructing a set of ground hit candidates G from the ground hits of the distance measure data based on the orientation of the eigenvectors ϵ₁ with the largest eigenvalues λ₁ of the Gaussian distributions, and determining a Gaussian distribution as a ground hit candidate if the angle between the eigenvector ϵ₁ and a plane parallel to the ground is below a certain threshold t_{G}.

In one further embodiment the method comprises:
determining height hᵢ of each of the plurality of histogram bins, where i∈[1,N] is the index of the histogram bin, that is the number of Gaussian distributions clustered in the ith histogram and N is the total amount of the plurality of histogram bins in the NDT histogram,
weighting the L₂ distance of the individual Gaussian distributions with an unnormalized weight wⱼ^{u} with index j belonging to the ith histogram bin as follows:

$${w}_{j}^{u} = \frac{1}{{h}_{i}} = {h}_{i}^{- 1}$$

normalizing the weights wⱼ of the jth Gaussian distributions as follows:

$${w}_{j} = \frac{{w}_{j}^{u}}{{\sum }_{k = 1}^{N} {h}_{k}^{- 1}} = \frac{{h}_{i}^{- 1}}{{\sum }_{k = 1}^{N} {h}_{k}^{- 1}}$$

and
adding the weights to the L₂ distance of individual Gaussian distributions wherein the NDT histogram weighted L₂^{w} distance is as follows:

$${L}_{2}^{w} ( t , \vert Z , ) = {\sum }_{i = 1}^{{N}_{Z}} - {d}_{1} exp ( - \frac{{d}_{2}}{2} {{μ}_{ij}^{T} ( {T}^{} {\sum }_{i} + {\sum }_{j} )}^{- 1} {μ}_{ij} ) {w}_{J}$$

$$where {μ}_{ij} = {μ}_{ij} ( t , ) = {μ}_{i} + t - {μ}_{j} and {w}_{J} = \frac{{h}_{I}^{- 1}}{{\sum }_{K = 1}^{N} {h}_{K}^{- 1}} .$$

According to one embodiment of the present invention there is also provided a computer program comprising computer program code means stored in storage medium adapted to perform the method as described in above embodiments, when executed by a computer.

According to one embodiment of the present invention there is provided a computer program which adapted to perform the method as described in above embodiments, embodied on a computer-readable medium.

The intuition in the subsample process is that the histogram is cut using an imaginary horizontal line, and the point cloud data samples above line are removed. This way the most common Gaussian distributions based on the clustering are removed, while the uncommon Gaussian distributions are preserved. The advantage is that the removal of important features from the scan which provide constraints to the scan alignment process may be alleviated.

### BRIEF DESCRIPTION OF THE DRAWINGS

In the following the invention is described in detail with reference to the accompanying drawings, in which

FIG. 1A shows a combined point cloud obtained from two 3D LiDARs,

FIG. 1B shows an NDT representation of the point cloud using a resolution of 0.8 meters,

FIG. 2 shows an illustration of the intuition in NDT histogram subsampling according to an embodiment of the invention,

FIG. 3 shows an example of an autonomous vehicle used in data gathering including the GNSS receiver and 3D LiDARs (front and rear),

FIG. 4 shows a 3D LiDAR point cloud map of the sparse environment,

FIG. 5 shows a trajectory used to test the performance of the method according to an embodiment of the invention,

FIG. 6 shows a 3D LiDAR point cloud map of the dense environment,

FIG. 7 shows a trajectory used to test the performance the method according to an embodiment of the invention,

FIG. 8 shows a comparison of lateral and heading mean absolute errors in vehicle frame with corresponding standard deviation,

FIG. 9 shows a comparison of lateral and heading mean absolute errors in vehicle frame using NDT histogram-based subsampling according to an embodiment of the invention,

FIG. 10 shows a comparison of lateral and heading mean absolute errors in vehicle frame using NDT histogram based L2 distance weighting according to an embodiment of the invention,

FIG. 11 shows a comparison of lateral and heading mean absolute errors in vehicle frame using both NDT histogram-based subsampling and L2 distance weighting according to embodiments of the invention.

### DETAILED DESCRIPTION OF THE INVENTION

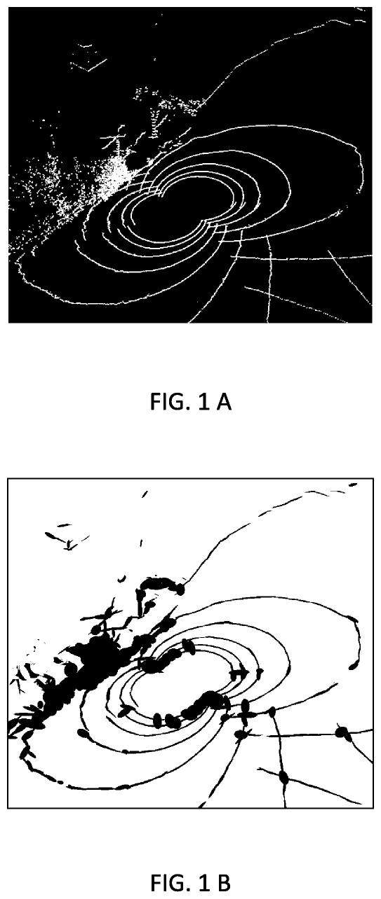

In the present disclosure, normal distributions transform (NDT) histogram is constructed directly from a single 3D LiDAR scan used by a self-driving vehicle. In a self-driving vehicle, a typical 3D LiDAR has 8 to 128 spinning laser beams, i.e. channels. When projected on a plane parallel to the 3D LiDAR, typically ground, the individual spinning lasers provide distance measures in a circular shape around the 3D LiDAR. The multiple laser beams are aligned in different angles, and the distance measures from each channel are combined to form a single point cloud. The resulting shape of the point cloud is roughly a set of circles of points with different radiuses. When the distances between the circles exceed the grid resolution of the constructed NDT representation, the resulting distributions take a linear shape as the individual circles fall into separate voxels, as is shown in examples of FIG. 1a, which shows a combined point cloud obtained from two 3D LiDARs, and FIG. 1b, which shows an NDT representation of the point cloud using a resolution of 0.8 meters. This is expected especially for the Gaussian distributions obtained furthest away from the 3D LiDAR since the point density decreases in proportion to the distance to the 3D LiDAR.

Since the linear distributions are classified in sub-classes based on their orientations, the linear distributions on a flat surface parallel to the laser beams of the 3D LiDAR, or some other range sensing device, such as camera, sensor, radar, GPS or sonar, may be classified in multiple different sub-classes due to the circular shape of the point cloud. However, in the present disclosure, the focus is in clustering the distributions based on the constraining features provided by the distributions for the point cloud matching process. Therefore, it is not beneficial to classify the linear distributions acquired from the same plane, such as the ground, into different sub-classes. Instead, in the present disclosure, the classification of linear distribution is modified such that the distributions acquired from the ground are separated in an additional histogram bin. The linear shaped Gaussian distributions obtained from the ground are aligned parallel to the ground, and thereby, a set of ground hit candidates G based on the orientation of the eigenvectors ϵ₁ with the largest eigenvalues λ₁ of the Gaussians may be constructed. A linear distribution is considered as a ground candidate if the angle between the eigenvector ϵ₁ and a plane parallel to the ground is below a threshold t_{g}.

The orientation of the ground plane is expected to be known since the self-driving vehicle is positioned to the ground level and its orientation. The approximation of the flat ground plane can be inaccurate in case of large ground surface variation. In this case, however, the non-flat portions of the ground provide constraints to the NDT matching process and do not produce similarly oriented linear distributions as the flat portions of the ground. If there are multiple levels of flat ground, there must be constraints providing features such as hills connecting the different levels of the ground. In the case of self-driving vehicles, it is expected that ground hits are very common, and therefore most of the ground candidates are expected to be actual ground hits. However, similarly oriented linear distributions, for example, from horizontally oriented features and from the horizontally aligned LiDAR laser beams that are projected on other flat surfaces such as walls, may be also obtained. To filter out the non-ground hits, the candidates are divided in multiple layers based on the heights of the Gaussian distributions, where the height is the distance in the direction perpendicular to the ground. By selecting the layer height hₗ, the candidates are grouped in subsets Gᵢ∈G, where i is the index of a layer. The subset Gᵢ with the largest amount of distributions is selected as the ground. Since the ground can exist near the middle of two layers, also a second layer Gᵢ₊₁ or Gᵢ₋₁ is merged to the most frequent layer based on which one of the two is more frequent. The remaining non-ground linear distributions are then clustered in different histogram bins. As a result, the linear distributions in different histogram bins now mostly provide different constraining features. The histogram can then be utilized, for example, when the point clouds are being aligned to ensure that all constraints are taken account properly.

Additionally, to ensure that also the planar distributions obtained from the ground are clustered in a single histogram bin, the evenly distributed directions of the histogram bins are rotated such that one of the directions is aligned with the normal of the ground plane. The same alignment is also performed on the histogram bin directions of the linear distributions to ensure that the common upward pointing linear shaped features such trees and poles are clustered in a single histogram bin. In the following, the modified NDT histogram, as discussed above, is utilized to ensure that different constraining features of a point cloud are taken account more evenly in the NDT matching process.

NDT Histogram Based Subsampling

As explained above, the NDT histogram provides information on the amount and the distribution of constraining features within the point cloud by clustering the Gaussian distributions of the normal distributions transformed scan. For example, if there are two peaks in the planar distribution histogram bins, there are two sets of nonparallel flat distributions in the NDT representation of the scan which may originate, for example, from the ground and a wall or building near the self-driving vehicle. Due to the modifications made in this present disclosure to the NDT histogram similar information from the linear distributions that are common in an NDT representation of a single 3D LiDAR scan may also be acquired. Since the distribution of the constraining features can be determined from the NDT histogram, it is possible to select the Gaussian distributions into the subsample based on the constraints given by the Gaussian distributions. The desired outcome is that the constraining features of the Gaussian distributions in the subsample are distributed more evenly, for example, to prevent evenly distributed particle likelihoods within the particle cloud in a particle filter in the L₂ distance based NDT matching process.

Let now N_{z} be the number of total Gaussian distributions in the NDT representation of the input LiDAR scan and N_{S}=rₛN_{Z} the desired amount of Gaussians in the subsample set S, where rₛ∈[0,1] is the subsample ratio. To obtain a subsample with more evenly distributed constraints, the selection of the Gaussian distributions is performed using following steps (steps 1.-6):
1. Construct a modified NDT histogram of the input 3D LiDAR scan Gaussian distributions.
2. Construct a vector h=[h₁, h₂, . . . , h_{N}], where hᵢ is the height of each histogram bin, i∈[1,N] is the index of the histogram bin and height means number of Gaussian distributions in a histogram bin and N is the total amount of histogram bins in the NDT histogram.
3. To include some amount of uniform subsampling, construct a vector u=[u₁, u₂, . . . , u_{N}]=[h₁rᵤrₛ, h₂rᵤrₛ, . . . , h_{N}rᵤrₛ], where uᵢ is the number of point cloud data samples to be removed from each histogram bin by uniform subsampling and rᵤ∈[0,1] is the uniform subsample ratio, that is the portion of subsampling to be performed uniformly to each histogram bin.
4. Construct a vector h^{u}=[h₁^{u}, h₂^{u}, . . . , h_{N}^{u}]=[h₁−u₁, h₂−u₂, . . . , h_{N}−u_{N}] that represents the histogram bin heights after uniform subsampling.
5. Construct a vector h^{s}=[h₁^{s}, h₂^{s}, . . . , h_{N}^{s}]=[h₁^{u}−s₁, h₂^{u}−s₂, . . . , h_{N}^{u}−s_{N}] representing the target height of each histogram bin after the complete subsampling process, where sᵢ is the number of the point cloud data samples to be removed from each histogram bin after uniform subsampling and the heights hᵢ^{s} are calculated such that the removals sᵢ are focused on the highest histogram bins until Σₖ₌₁^{N}hₖ^{s}=N_{S} to produce as even heights hᵢ^{s} as possible.
6. Randomly select hᵢ^{s} Gaussian distributions from the corresponding histogram bins and add them to the subsample set S.

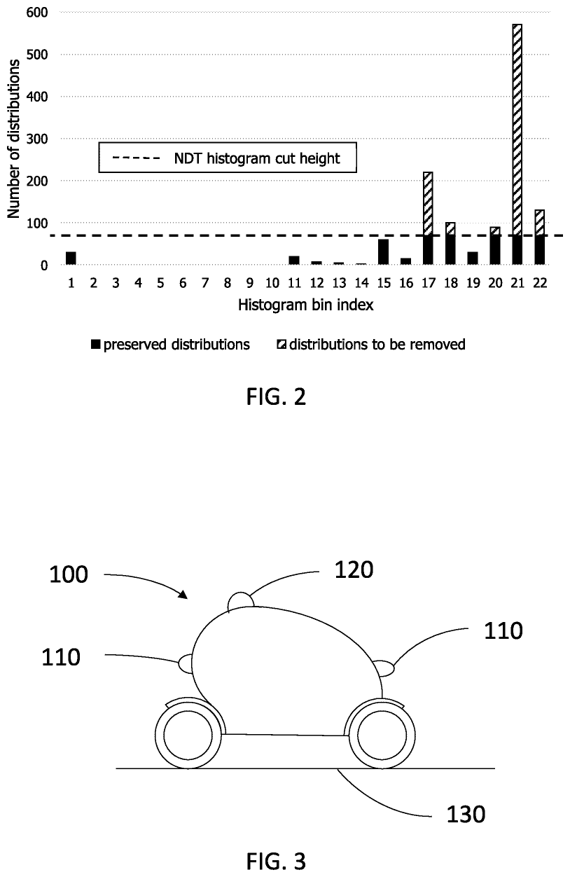

An illustration of the removal is shown in FIG. 2, in which the dashed line denotes the NDT histogram cut height, preserved distributions are shown as solid black histograms and distributions to be removed as black-striped histograms. In case the original shape of the histogram to some extent need to be preserved, some of the samples are selected uniformly from each histogram bin before the cut.

NDT Histogram Based L₂ Distance Weighting

The L₂ distance based NDT matching weights each Gaussian distributions match uniformly regardless of the constraints (or constraining features) provided by the Gaussian distributions. To weight different constraints more evenly, the removals in the previously described subsampling method are focused on the most common Gaussian distributions. However, in that case the weights of the constraints are dependent on the subsample ratio rₛ. If the amount of subsampling is low, the weights of the constraints remain mostly the same as before the subsampling. In order to weight the constraints independent of the subsample ratio, it is possible to weight the L₂ distance of the individual Gaussians based on NDT histogram. Since the height of a histogram bin describes how common a Gaussian distribution belonging to that bin is, the weights should be inversely proportional to the heights of the histogram bins. Let h; be the height of a histogram bin with index i, which is the number of Gaussian distributions clustered into the ith histogram bin. The unnormalized weight wⱼ^{u} of an individual Gaussian distribution with index j belonging to the ith histogram bin is

$${w}_{j}^{u} = \frac{1}{{h}_{i}} = {h}_{i}^{- 1} \qquad ( 1 )$$

To scale the weights in range [0,1], the weights are divided by the sum of the weights. The normalized weight wⱼ of jth Gaussian distribution is

$${w}_{j} = \frac{{w}_{j}^{u}}{{\sum }_{k = 1}^{N} {h}_{k}^{- 1}} = \frac{{h}_{i}^{- 1}}{{\sum }_{k = 1}^{N} {h}_{k}^{- 1}} \qquad ( 2 )$$

where N is the number of histogram bins. The weight can be directly added as a weight to the L₂ distance of individual Gaussian distributions. To avoid collision with the original indices i and j in the L₂ distance equation, as explained by Stoyanov et al. (in T. Stoyanov, M. Magnusson, H. Andreasson, and A. J. Lilienthal, “Fast and accurate scan registration through minimization of the distance between compact 3D NDT representations,” The International Journal of Robotics Research, vol. 31, no. 12, pp. 1377-1393, 2012), the weight related indices in equation (2) will be mapped to i→I, j→J and k→K. The NDT histogram weighted L₂^{w} distance is

$${L}_{2}^{w} ( t , \vert Z , ) = {\sum }_{i = 1}^{{N}_{Z}} - {d}_{1} exp ( - \frac{{d}_{2}}{2} {{μ}_{ij}^{T} ( {T}^{} {\sum }_{i} + {\sum }_{j} )}^{- 1} {μ}_{ij} ) {w}_{J} \qquad ( 3 )$$

$$where {μ}_{ij} = {μ}_{ij} ( t , ) = {μ}_{i} + t - {μ}_{j} and {w}_{J} = \frac{{h}_{I}^{- 1}}{{\sum }_{K = 1}^{N} {h}_{K}^{- 1}} .$$

The L₂^{w} distance is approximated in the same way as shown by Saarinen et al. (in J. Saarinen, H. Andreasson, T. Stoyanov, and A. J. Lilienthal, “Normal distributions transform Monte-Carlo localization (NDT-MCL),” in IEEE/RSJ International Conference on Intelligent Robots and Systems, pp. 382-389, 2013) such that each scan Gaussian is only matched to the Gaussian in a map voxel where the mean of the scan Gaussian falls into. The L₂^{w} distance approximation is optional. Another way of approximation may be to match the scan Gaussian to the corresponding map Gaussian and also to the nearest neighboring Gaussian as well.

The effect of the weight wⱼ is that the distances of individual distributions with high weights are have more effect on the total L₂^{w} distance than the distances of distributions with low weights. In other words, more uncommon individual Gaussians have more impact on the total L₂^{w} distance than the more frequent types Gaussians. Therefore, rare features have a higher impact on the optimization of the L₂^{w} distance based objective function in NDT registration (in T. Stoyanov, M. Magnusson, H. Andreasson, and A. J. Lilienthal, “Fast and accurate scan registration through minimization of the distance between compact 3D NDT representations,” The International Journal of Robotics Research, vol. 31, no. 12, pp. 1377-1393, 2012), and on the L₂^{w} distance-based particle likelihoods in a particle filter (in J. Saarinen, H. Andreasson, T. Stoyanov, and A. J. Lilienthal, “Normal distributions transform Monte-Carlo localization (NDT-MCL),” in IEEE/RSJ International Conference on Intelligent Robots and Systems, pp. 382-389, 2013).

Evaluation of the Method

In the following an experimental setup used to test the performance of the method according to the present invention is presented. The following describes data gathering procedures in two different testing environments, where one environment is feature-sparse and the other is a more common dense-structured environment. The localization algorithm used to evaluate the method of the invention is normal distribution transform Monte-Carlo localization (NDT-MCL). However, the methods are not tied to this particular localization method.

The self-driving vehicle used for evaluating the above described method is a two-seated electrical self-driving car 100 shown in FIG. 3. Being an autonomously operable, the self-driving car 100 may identify its surroundings and move without human input. It may comprise various sensors for detecting the environment, such as radar, LiDAR, GPS, odometer and internal measurement units, and thereby the self-driving car may run independently along the surfaces of the surrounding environment 130, such as the ground, parking lot, plane, open field or road.

The self-driving car 100, in this experimental setup, contains two range sensing devices 110 which both are 16-channel Velodyne VLP-16 3D LiDARs with a range of meters. The LiDARs are installed in the front bumber (front LiDAR) and rear bumper (rear LiDAR) of the self-driving car such that the LiDARs are roughly 0 degrees inclination (i.e. level to the ground). The data from both LiDARs (front LiDAR and rear LiDAR) 110 is received and combined in the localization algorithm by a computing device having a processor and a memory. Said computing device may be arranged in the self-driving car 100 such that the self-driving car is in communication with the computing device, the self-driving car being configured to be controllable and localizable in the environment surrounding the self-driving car according to localization algorithm based on NDT histogram based subsampling and/or NDT histogram based L2 distance weighting, as described above. The computing device used for the self-driving car 100 to run the proposed methods is a laptop with Intel Core i7-8750H 6-core (multithreaded to 12 threads) CPU and 16 gigabytes of memory. The included GPU is an NVIDIA GeForce GTX 1060. The methods are purely running on the CPU and the available GPU is only used in the optional visualization of the algorithm. The NDT maps are loaded from an M.2 solid-state drive.

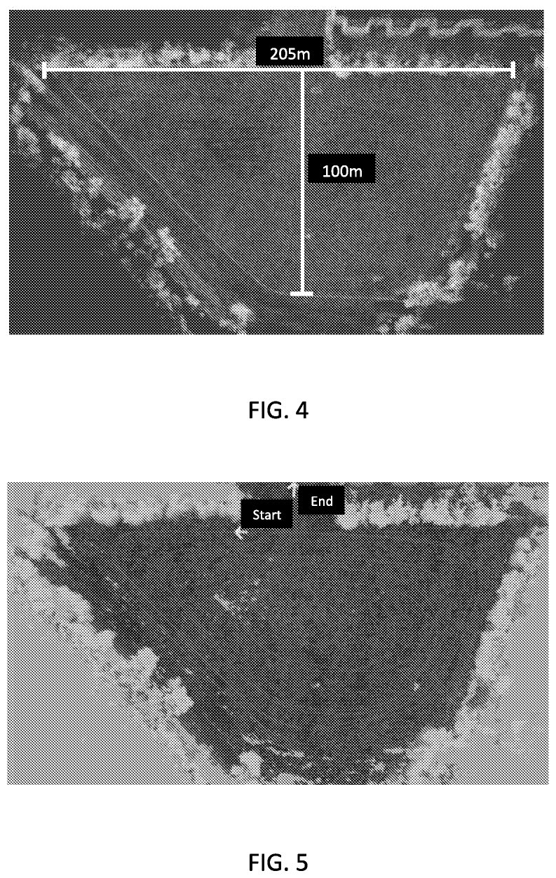

The point clouds (data) of the two LiDARs 110 are configured to be combined by using the transformations from the LiDARs to the base link. The point clouds are also configured to be rectified based on estimated poses from an EKF (extended Kalman Filter) using wheel odometry and an internal measurement unit (IMU). The IMU was a LORD Microstrain 3DM-GX5-25 that contains an accelerometer, a gyroscope and a magnetometer. However, the magnetometer data is not utilized in the localization method used in this experiment (i.e. NDT-MCL). In addition to point cloud rectification, the IMU and wheel odometry data is used to provide an initial guess to the particle filter in NDT-MCL by fusing the data using an EKF. The self-driving car 100 is also provided with a (ComNav T300) real-time kinematic global navigation satellite system (RTK-GNSS) receiver 120, which provides centimeter-level accurate reference positioning for the localization algorithm in good conditions. The RTK-GNSS 120 data is also fused with the IMU and wheel odometry using an EKF. This reference position is used as the ground truth to evaluate the performance of the proposed methods. Additionally, the fused RTK-GNSS 120 position will be used to initialize NDT-MCL algorithm. However, the usage of the reference positioning is turned off after the initialization phase, and afterwards the localization is only based on the IMU, wheel odometry and 3D LiDAR data. The focus of the method according to the embodiments of the present disclosure is on sparse environments. Therefore, the testing area is chosen such that there are only a few constraining features for the LiDAR point cloud matching. The chosen sparse environment is an almost empty parking lot with a couple of cars parked near the sides of the parking lot and a lamp pole near the center. The 3D LiDAR map of the area that used for localization is shown in FIG. 4 as a point cloud. The NDT representation of the map is constructed using a voxel size of 0.8 m×0.8 m×0.8 m (i.e. 0.8 m resolution), which shown in FIG. 5.

The trajectory used for evaluation of method (as described in paragraphs “NDT histogram based subsampling” and “NDT histogram based L2 distance weighting”) is presented in FIG. 5. The trajectory starts from the edges of the parking lot, where there are building and trees visible to the LiDARs providing fair amount of constraints for the NDT matching process. The trajectory continues in a circular pattern towards the center of the parking lot, where amount of constraining features is low. Even though the lamp pole is visible to the LiDAR in addition to some of the trees and buildings at the sides, most of the LiDAR points are ground hits when driving in the middle of the parking lot. The trajectory ends at the side of the parking lot.

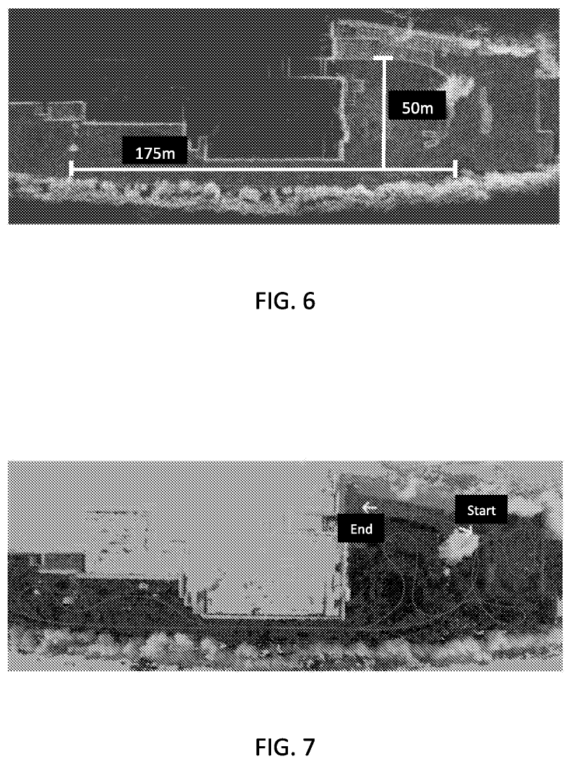

Even though the focus of the invention is on localization in sparse environments, the method also works in dense-structured environments. The goal in the experiment is to reach at least equally performing localization as without the proposed methods such that the methods can be used in any environments without a need to switch between the algorithms. Therefore, the second testing environment should be diverse and feature dense. The chosen environment for testing is an office building surroundings that contains objects such as fences, trees and parked cars. The point cloud map of the environment is shown in FIG. 6, and the corresponding NDT representation is shown in FIG. 7. The resolution of the NDT map is the same 0.8 meters as in the sparse environment described previously. The trajectory follows a road next to the building containing movement in all three dimensions. Along the road, there are multiple small parking lots where the LiDARs always capture a decent amount of constraining features for the NDT matching process. The trajectory is presented in FIG. 7.

The NDT histogram-based subsampling and L₂ distance weighting described in previous paragraphs are designed to improve the localization accuracy especially in sparse environments. The methods are evaluated in the following both separately and as combined. The accuracy is evaluated by comparing the estimated trajectory to the RTK-GNSS, IMU and wheel odometry based ground truth trajectory, where the data is fused using an EKF. The translational error of ground truth trajectory is expected to be few centimeters. The focus is on evaluating the lateral positioning accuracy in vehicle frame since poor lateral accuracy can lead into situations where the vehicle drifts to the adjacent lanes which can lead into a crash with other vehicles or obstacles along the road. Furthermore, lateral positioning errors can be problematic for the vehicle motion controller while driving autonomously, since the vehicle must be guided to the predefined path by steering the vehicle, which can cause issues such as oscillation. Another important measurement is the heading accuracy of the vehicle for similar reasons as with the lateral accuracy. However, the localization errors in the other dimensions are also evaluated and discussed briefly in this section. The translation and rotation error to the reference trajectory are given as mean absolute error (MAE), mean bias error (MBE) and root-mean-square error (RMSE) in vehicle frame with the corresponding standard deviations. The MAE, MBE and RMSE are defined as

$$M A E = \frac{{\sum }_{i = 0}^{N} \vert {p}_{i}^{ref} - {p}_{i}^{meas} \vert}{N} \qquad ( 4 )$$

$$M B E = \frac{{\sum }_{i = 0}^{N} ( {p}_{i}^{ref} - {p}_{i}^{meas} )}{N} \qquad ( 5 )$$

$$R M S E = \sqrt{\frac{{\sum }_{i = 0}^{N} {( {p}_{i}^{ref} - {p}_{i}^{meas} )}^{2}}{N}} \qquad ( 6 )$$

where N is the number of points in the trajectory, pᵢ^{ref} is a reference 6D pose and pᵢ^{meas} is an estimated 6D pose in the vehicle frame. The 6D poses consist of a 3D translation t=[tₓ, t_{y}, t_{z}] and a 3D orientation in extrinsic Euler angles r=[roll,pitch,yaw].

The localization methods were executed in real-time using offline sensor data. Even though the data is the same each time the algorithms are executed, the localization algorithm is non-deterministic due to the real-time execution, randomness in the noise of the particle poses and computational performance issues. Since there is variation in the results between each execution, the algorithms were ran five times for each method and the presented results are the corresponding mean values.

The modified NDT histogram was constructed using 10 planar histogram bins and linear histogram bins including the ground bin. Based on experimentation, using more than one spherical bins does not improve the performance of the methods, and thus the spherical distributions were not further clustered based on the roughness values. In NDT histogram based subsampling, the uniform subsample ratio was selected as ru=0.0 such that the effect of the NDT histogram subsampling was maximized. The subsample ratio was experimentally set to the lowest possible value to increase the execution speed of the localization algorithm such that the accuracy of the algorithm didn't decrease notably. Additionally, performing a large amount of subsampling increases the effect of the proposed subsampling method to the localization accuracy. In both random and NDT histogram based subsampling, the subsample ratio was set to rs=0.15, i.e. 85 percent of the distributions were removed. The rest of the parameters are identical between the original and the proposed methods.

The construction time of the NDT histogram with the given parameters was below 1 milliseconds. The subsampling part and the weight calculations were performed in less than 0.1 milliseconds for the LiDAR data used in the experiments. Since the overall duration of a full execution of one step in the NDT-MCL algorithm is typically 50-200 milliseconds, the overhead caused by the NDT histogram calculations is not significant. The numerical results of the NDT histogram based subsampling and weighting methods are presented in Tables 3, 4, 5 and 6. The Tables 3 and 4 contain comparison of lateral and heading errors in the sparse environment described previously with the different proposed methods and the original localization method.

For comparison, the same measurements are presented in Tables 5 and 6 for the dense environment described previously. The tables contain mean absolute errors (MAE), standard deviation of the absolute errors (AE), maximum AE, mean bias errors (MBE) and root-mean-square errors (RMSE). Additionally, the relative mean absolute errors compared to the original method are provided as percentage values. For the proposed methods, improved values compared to the original method are bolded in the tables.

Table 3 shows that the lateral errors and the corresponding standard deviations in all proposed methods are significantly lower than in the original localization method in the sparse environment. The lateral accuracy is similar in each proposed method but the combined method resulted in slightly better accuracy than the other two. The maximum lateral error of the combined method is over halved in the combined method compared to the original algorithm. However, there is notable variance in the maximum errors each time the algorithms are ran. The mean biases with the proposed methods were low even though most of the turns in the trajectory are taken in the same direction.

TABLE 3
Comparison of lateral errors (in meters) of the different methods
in the sparse environment. For the proposed methods,
improved values compared to the original method are bolded.

| Method | MAE | MAE (%) | AE Std | AE max | MBE | RMSE |
|---|---|---|---|---|---|---|
| Original | 0.103 | 100 | 0.110 | 0.876 | 0.016 | 0.151 |
| Subsampling | 0.062 | 60.2 | 0.057 | 0.373 | −0.002 | 0.084 |
| Weighting | 0.062 | 60.2 | 0.052 | 0.332 | 0.001 | 0.081 |
| Combined | 0.060 | 58.3 | 0.053 | 0368 | 0.007 | 0.080 |

The heading errors in addition to the corresponding standard deviations were slightly decreased by the proposed methods as shown in Table 4. The worst case of the NDT histogram based weighting and the combined method were similar as in the original method as seen from the maximum absolute heading errors. In the NDT histogram based subsampling method, the maximum heading error was slightly larger. However, similarly as in lateral maximum errors, there was significant variance in the maximum errors between the executions of the algorithms.

TABLE 4
Comparison of heading errors (in degrees) of the
different methods in the sparse environment.

| Method | MAE | MAE (%) | AE Std | AE max | MBE | RMSE |
|---|---|---|---|---|---|---|
| Original | 0.350 | 100 | 0.357 | 6.497 | 0.087 | 0.500 |
| Subsampling | 0.293 | 83.7 | 0.320 | 8.057 | 0.024 | 0.434 |
| Weighting | 0.299 | 85.4 | 0.324 | 6.703 | 0.023 | 0.441 |
| Combined | 0.305 | 87.1 | 0.331 | 5.899 | 0.020 | 0.450 |

Table 5 presents a comparison of lateral errors (in meters) of the different methods in the dense environment. Even though the proposed methods are designed for sparse environments, the results are promising since the lateral errors are slightly lower than in the original method. Table 6 shows a comparison of heading errors (in degrees) of the different methods in the dense environment. The heading errors in Table 6 for the same environment are mostly unchanged compared to the original localization algorithm.

TABLE 5
Comparison of lateral errors (in meters) of the
different methods in the dense environment.

| Method | MAE | MAE (%) | AE Std | AE max | MBE | RMSE |
|---|---|---|---|---|---|---|
| Original | 0.085 | 100 | 0.074 | 0.448 | 0.007 | 0.113 |
| Subsampling | 0.079 | 92.9 | 0.070 | 0.474 | 0.006 | 0.106 |
| Weighting | 0.079 | 92.9 | 0.072 | 0.465 | 0.014 | 0.107 |
| Combined | 0.075 | 88.2 | 0.064 | 0.401 | 0.006 | 0.099 |

TABLE 6
Comparison of heading errors (in degrees) of
the different methods in the dense environment.

| Method | MAE | MAE (%) | AE Std | AE max | MBE | RMSE |
|---|---|---|---|---|---|---|
| Original | 0.523 | 100 | 0.511 | 4.218 | 0.052 | 0.731 |
| Subsampling | 0.519 | 99.2 | 0.506 | 8.117 | 0.050 | 0.724 |
| Weighting | 0.515 | 98.5 | 0.490 | 5.487 | 0.038 | 0.711 |
| Combined | 0.516 | 98.7 | 0.491 | 8.407 | 0.046 | 0.712 |

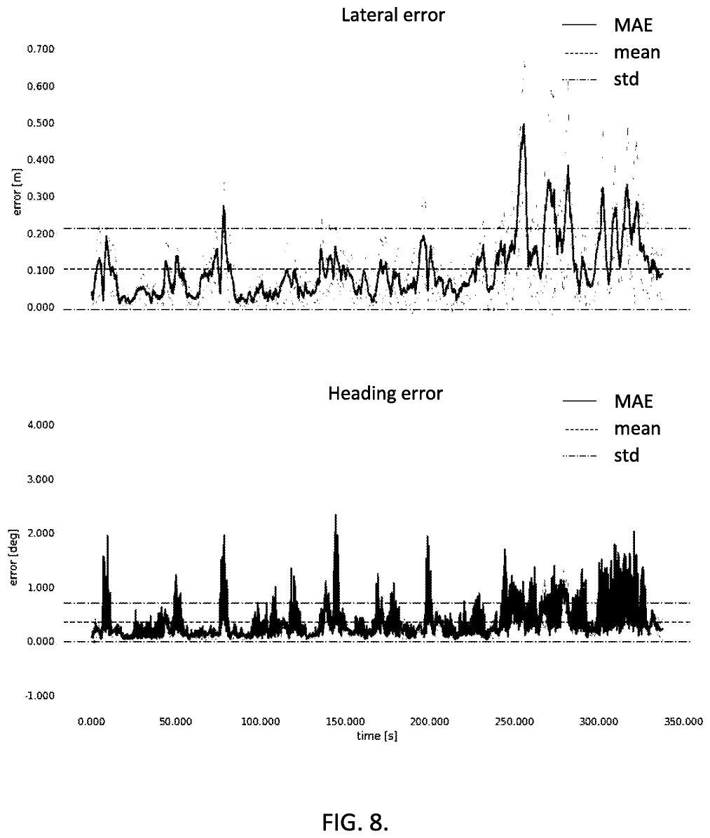

The lateral and heading mean absolute errors for the sparse environment are also presented in FIGS. 8-11 for each method. The FIGS. 8-11 present the mean absolute errors (dark blue) for the whole trajectory with the standard deviations of the five executions (light blue). Additionally, the MAE and AE standard deviation of the whole trajectory are shown as horizontal lines over the figures.

As mentioned previously, the trajectory starts from the edges of the parking lot and continues to the middle of the parking lot, where the amount of environmental features is the lowest. The effect of the low amount of features can be seen clearly in FIG. 8, where the lateral and heading errors increase near the end of the data set. Another reason to the increased lateral error is probably the increased turning rate in the middle of the parking lot while the vehicle was driven in smaller circles.

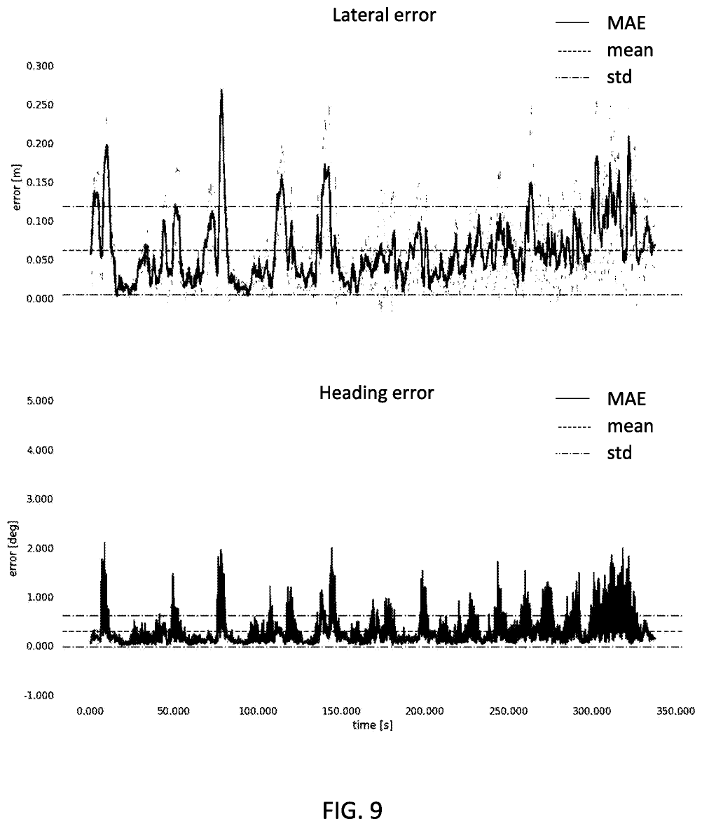

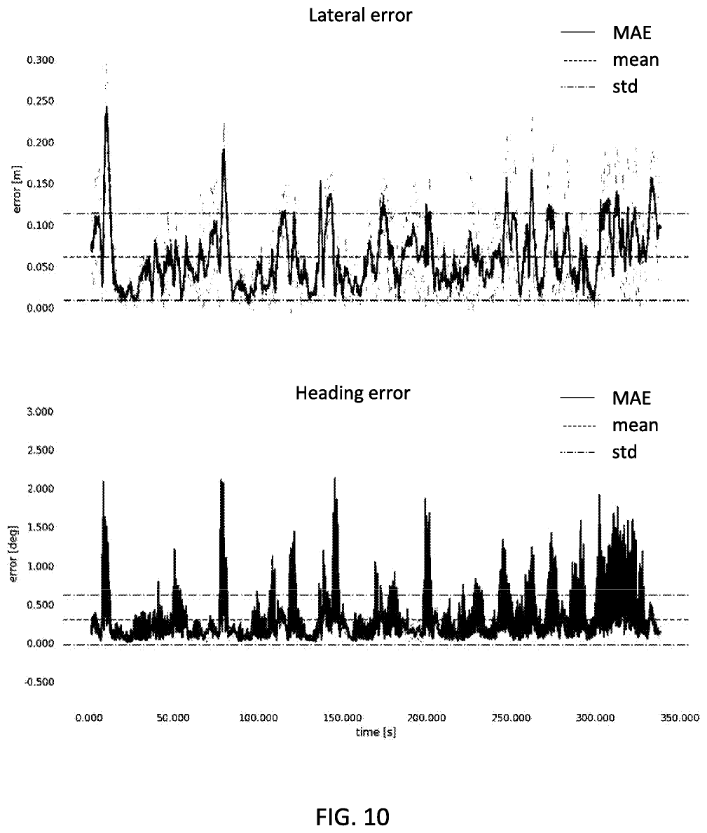

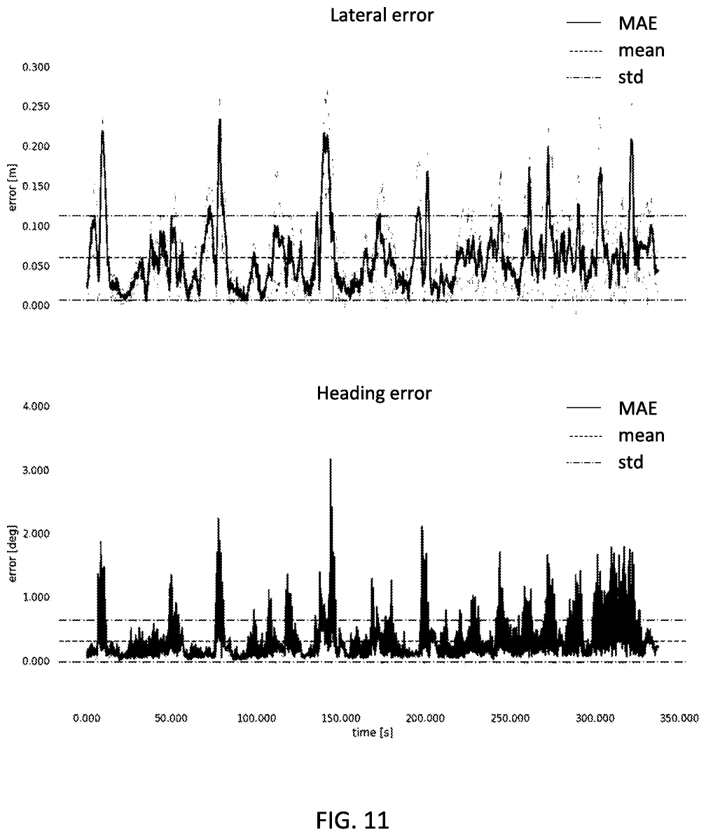

However, from FIG. 9 it can be noticed that especially the lateral error does not increase as much in the middle of the parking lot in the NDT histogram based subsampling method compared to the original algorithm. Additionally, the overall standard deviation of the MAE is clearly lower compared to the original method. The spikes in both heading and lateral errors seem to happen in the same parts of the trajectories, which are mostly resulting from the turns in the trajectories. Both the NDT histogram based weighting and the combined methods seem to perform very similarly to the NDT histogram based subsampling method as seen in FIGS. 10 and 11. This is expected, since the effects of the subsampling and weighting methods are supposed to be similar due to the same clustering method, i.e. the modified NDT histogram, used as the basis for the both methods.

The comparison of localization errors between the original and the combined NDT histogram based subsampling and weighting methods is presented in Tables 7 and 8, respectively. The separated NDT histogram based subsampling and weighting methods yield very similar results as the combined method and such those comparisons are not presented. In the tables, the translation and rotation errors are given in the vehicle frame such that x, y, and z correspond to longitudinal, lateral and altitudinal directions. Roll, pitch and yaw are the rotations around the x, y and z axes in the given order.

The comparison reveals that x, roll, pitch and yaw accuracies were not significantly affected by the proposed methods. However, there was notable increase in altitudinal MAE compared to the original method, which is expected since the proposed methods tend to weight the z-constraint providing ground hits less than the original method in sparse environments. However, since the z-error is low despite the increase, the effects to the localization with self-driving cars is quite non-existent since the altitude of the vehicle is fixed to the ground level. Since the crucial lateral accuracy is significantly improved and the computational overheads of the proposed methods are low, the proposed methods outperform the original method in sparse environments. Additionally, since the accuracies are similar between the proposed and original methods in the dense environment, the proposed methods are suitable for changing environments as well.

TABLE 7
Comparison of localization errors in vehicle frame for each dimension
in the sparse environment for the original localization method.

| Dimension | MAE | MAE (%) | AE Std | AE max | MBE | RMSE |
|---|---|---|---|---|---|---|
| x [m] | 0.180 | 100 | 0.140 | 2.724 | 0.016 | 0.228 |
| y [m] | 0.103 | 100 | 0.110 | 0.876 | 0.016 | 0.151 |
| z [m] | 0.072 | 100 | 0.073 | 0.901 | 0.066 | 0.103 |
| roll [deg] | 0.210 | 100 | 0.159 | 1.066 | 0.036 | 0.263 |
| pitch [deg] | 0.456 | 100 | 0.280 | 3.542 | −0.406 | 0.535 |
| yaw [deg] | 0.350 | 100 | 0.357 | 6.97 | 0.087 | 0.500 |

TABLE 8
Comparison of localization errors in vehicle frame for each dimension
in the sparse environment for the combined NDT histogram based
subsampling and L2 distance weighting method. Improved values
compared to the original method are bolded.

| Dimension | MAE | MAE (%) | AE Std | AE max | MBE | RMSE |
|---|---|---|---|---|---|---|
| x [m] | 0.162 | 90.0 | 0.121 | 1.970 | 0.002 | 0.202 |
| y [m] | 0.060 | 58.3 | 0.053 | 0.368 | 0.007 | 0.080 |
| z [m] | 0.094 | 130.6 | 0.093 | 0.945 | 0.071 | 0.132 |
| roll [deg] | 0.238 | 113.3 | 0.186 | 1.421 | 0.009 | 0.302 |
| pitch [deg] | 0.368 | 80.7 | 0.297 | 3.461 | −0.274 | 0.473 |
| yaw [deg] | 0.305 | 87.1 | 0.331 | 5.899 | 0.020 | 0.450 |

One important note on the given localization accuracies is that the they also include errors from other sources such as mapping and ground truth errors. As mentioned, the ground truth error is expected to be few centimeters. The mapping error is hard to measure accurately in the absence of a ground truth map. The mapping related issues are expected to induce a localization error of a few centimeters.

The methods described above in connection with figures and tables may also be carried out in the form of one or more computer process defined by one or more computer programs. This may be, for example, a computer program comprising computer program code means stored in storage medium adapted to perform the method of any of steps, when executed by a computer. The computer program shall be considered to also encompass a module of a computer programs, e.g. the above-described processes may be carried out as a program module of a larger algorithm or a computer process. The computer program(s) may be in source code form, object code form, or in some intermediate form, and it may be stored in a carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst several processing units.

It will be obvious to a person skilled in the art that, as the technology advances, the inventive concept can be implemented in various ways. The invention and its embodiments are not limited to the examples described above but may vary within the scope of the claims.

1. A computer-implemented method for improving localization accuracy of a self-driving vehicle, wherein the method comprises:
receiving from one or more range sensing devices point cloud data related to surface characteristics of an environment in which the self-driving vehicle is moving;
based on receiving the point cloud data, constructing a normal distributions transform (NDT) histogram having a set of Gaussian distributions in a plurality of histogram bins, each of the plurality of histogram bins providing different constraining features, wherein the constraining features represent the characteristics of the environment;
determining a height of each of the plurality of histogram bins, where the height means the number of Gaussian distributions in a histogram bin, the heights of the histogram bins representing commonness or uncommonness of the Gaussian distributions in the NDT histogram;
constructing a modified set of Gaussian distributions based on the NDT histogram and the heights of the histogram bins, wherein the constructing of the modified set comprises at least one of:
i. subsampling the NDT histogram to such that the heights of histogram bins with most common Gaussian distributions are reduced, and
ii. weighting the histogram bins based on the heights of the histogram bins, wherein uncommon Gaussian distributions in the NDT histogram are given more weight than common Gaussian distributions; and
providing the modified set to be used to localize the self-driving vehicle with respect to the point cloud data received.

2. The method according to claim 1, wherein the subsampling comprises:
performing subsampling for the histogram bins in the constructed NDT histogram to construct a target height vector h^{s} representing a target height hᵢ^{s} of each histogram bin, wherein the subsampling comprises removing at least some Gaussian distributions from histogram bins with most common Gaussian distributions;
after subsampling, selecting hᵢ^{s} Gaussian distributions from the corresponding histogram bins of the target height vector h^{s} based on the constraining features given by the Gaussian distributions and adding them to a subsample set S; and
using the subsample set S as the modified set of distributions.

3. The method according to claim 1, wherein the step of constructing a modified NDT histogram comprises:
providing distance measure data around said one or more range sensing devices, and based on providing said data, resulting point cloud data to form a set of linear Gaussian distributions; and
clustering said linear Gaussian distributions based on the constraining features provided by said distributions, wherein the clustering is executed by modifying said distributions such that the distributions acquired from a ground surface represented by ground hits of the distance measure data are separated in an additional histogram bin.

4. The method according to claim 3, wherein the method comprises:
dividing said distance measure data in multiple layers based on the heights of said distributions, where the height is the distance in a direction perpendicular to the ground along which said self-driving vehicle is moving, and grouping said distance measure data in subsets Gᵢ∈G, where i is the index of a layer; and
selecting the subset Gᵢ with the largest amount of distributions as the ground and the remaining non-ground distributions are clustered in different histogram bins.

5. The method according to claim 4, wherein the selecting of the subset Gᵢ comprises:
merging a consecutive subset Gᵢ₊₁ or Gᵢ₋₁ to the subset Gᵢ based on which one of the two consecutive subsets Gᵢ₊₁ and Gᵢ₋₁ has more distributions.

6. The method according to claim 3, wherein the method comprises:
constructing a set of ground hit candidates G from the ground hits of the distance measure data based on the orientation of eigenvectors ϵ₁ with the largest eigenvalues λ₁ of the linear Gaussian distributions; and
determining a linear Gaussian distribution as a ground hit candidate if the angle between the eigenvector ϵ₁ and a plane parallel to the ground is below a certain threshold t_{G}.

7. The method according to claim 2, wherein the step of performing subsampling comprises:
constructing a vector u=[u₁, u₂, . . . , u_{N}]=[h₁rᵤrₛ, h₂rᵤrₛ, . . . , h_{N}rᵤrₛ], where hᵢ is the height of each of the plurality of histogram bins, i∈[1,N] being an index of the histogram bin and N being a total amount of the plurality of histogram bins in the NDT histogram, uᵢ is a number of point cloud data samples to be removed from each histogram bin by uniform subsampling, and rᵤ∈[0,1] is [a] uniform subsample ratio representing a portion of subsampling to be performed uniformly to each histogram bin, and rₛ∈[0,1] is a subsample ratio;
constructing a uniform subsampling height vector h^{u}=[h₁^{u}, h₂^{u}, . . . , h_{N}^{u}]=[h₁−u₁, h₂−u₂, . . . , h_{N}−u_{N}] that represents the histogram bin heights after uniform subsampling; and
constructing the target height vector h^{s}=[h₁^{s}, h₂^{s}, . . . , h_{N}^{s}]=[h₁^{u}−s₁, h₂^{u}−s₂, . . . , h_{N}^{u}−s_{N}] representing the target height of each histogram bin in the constructed NDT histogram, where sᵢ is the number of the point cloud data samples to be removed from each histogram bin and the heights hᵢ^{s} are calculated such that the removals sᵢ are focused on the highest histogram bins until a sum of the target heights hᵢ^{s} in vector h^{s} equal the desired number N_{S} of distributions.

8. The method according to claim 1, wherein the weighting comprises:
determining height hᵢ of each of the plurality of histogram bins, where i∈[1,N] is an index of the histogram bin representing a number of Gaussian distributions clustered in the ith histogram and N is a total amount of the plurality of histogram bins in the NDT histogram; and
weighting an L₂ distance of the individual Gaussian distributions with an unnormalized weight wⱼ^{u} with index j belonging to the ith histogram bin as follows:
$${w}_{j}^{u} = \frac{1}{{h}_{i}} = {h}_{i}^{- 1}$$
normalizing weights wⱼ of the jth Gaussian distributions as follows:
$${w}_{j} = \frac{{w}_{j}^{u}}{{\sum }_{k = 1}^{N} {h}_{k}^{- 1}} = \frac{{h}_{i}^{- 1}}{{\sum }_{k = 1}^{N} {h}_{k}^{- 1}}$$
adding the weights to the L₂ distance of individual Gaussian distributions wherein the NDT histogram weighted L₂^{w} distance is as follows:
$${L}_{2}^{w} ( t , \vert Z , ) = {\sum }_{i = 1}^{{N}_{Z}} - {d}_{1} exp ( - \frac{{d}_{2}}{2} {{μ}_{ij}^{T} ( {T}^{} {\sum }_{i} + {\sum }_{j} )}^{- 1} {μ}_{ij} ) {w}_{J}$$
$$where {μ}_{ij} = {μ}_{ij} ( t , ) = {μ}_{i} + t - {μ}_{j} and {w}_{J} = \frac{{h}_{I}^{- 1}}{{\sum }_{K = 1}^{N} {h}_{K}^{- 1}} .$$

9. The method according to claim 1 further comprising
using the modified set to localize the self-driving vehicle with respect to the point cloud data.

10. A non-transitory computer-readable medium storing program instructions that, when executed by a processor, cause the processor to perform a method for improving localization accuracy of a self-driving vehicle comprising:
receiving from one or more range sensing devices point cloud data related to surface characteristics of an environment in which the self-driving vehicle-is moving;
based on receiving the point cloud data, constructing a normal distributions transform (NDT) histogram having a set of Gaussian distributions in a plurality of histogram bins, each of the plurality of histogram bins providing different constraining features, wherein the constraining features represent the characteristics of the environment;
determining a height of each of the plurality of histogram bins, where the height means the number of Gaussian distributions in a histogram bin, the heights of the histogram bins representing commonness or uncommonness of the Gaussian distributions in the NDT histogram;
constructing a modified set of Gaussian distributions based on the NDT histogram and the heights of the histogram bins, wherein the constructing of the modified set comprises at least one of:
i. subsampling the NDT histogram to such that the heights of histogram bins with most common Gaussian distributions are reduced, and
ii. weighting the histogram bins based on the heights of the histogram bins, wherein uncommon Gaussian distributions in the NDT histogram are given more weight than common Gaussian distributions; and
providing the modified set to be used to localize the self-driving vehicle with respect to the point cloud data received.

11. (canceled)
